(19) United States
(12) Patent Application Publication
(10) Pub. No.: US 2004/0212309 A1
(43) Pub. Date: Oct. 28, 2004

(54) Intelligent LED traffic signals modules

(76) Inventor: Nicolas St.-Germain, Lachine (CA)

Correspondence Address: ORUM & ROTH, 53 W. JACKSON BLVD, CHICAGO, IL, 60604, US

(21) Appl. No.: 10/762,743

(22) Filed: Jan. 22, 2004

Related U.S. Application Data
(60) Provisional application No. 60/442,082, filed on Jan. 23, 2003.

(51) Int. Cl. H05B 37/02

(52) U.S. Cl. 315/76; 315/200 A; 315/291; 315/294

(57) ABSTRACT

An intelligent LED module for an LED traffic signal. The module controller generates control signals, including an on signal, an off signal, a dimming signal, a flashing signal and/or an emergency disconnect signal. The intelligent LED module also provides feedback to the controller including light output status, LED current, LED voltage, input voltage and/or input current.

This application claims the benefit of U.S. Provisional Application 60/442082 filed Jan. 23, 2003 entitled “Intelligent LED Traffic Signals Modules”.

### BACKGROUND OF THE INVENTION

1. Field of the Invention

The present invention relates to traffic signals, more specifically it relates to light emitting diode traffic signals.

2. Description of Related Art

Technology of light emitting diode (LED) traffic signals is well established and in use worldwide. Most LED traffic signals usage is for retrofit on existing traffic controllers. The controller turns traffic signals on and off through load switches and detects signal integrity through conflict monitoring (North America) or through current monitoring (Europe, Asia, Australia). These features were intended for incandescent lamp based systems. The present invention comprises an intelligent LED module, able to receive control signals and gives a status on several LED signal vital parameters, paving the way for a next generation of simpler and safer traffic controllers.

### SUMMARY OF THE INVENTION

The present invention relates to an intelligent LED module for an LED traffic signal. The inventive module is able to receive control signals. The control signals may include one or more of the following control signals: on, off, dimming, flashing and/or emergency disconnect. The use of control signals eliminates the need for several separate modules in the controller. Additionally, the intelligent LED module provides feedback to the controller on several status indicators.

### BRIEF DESCRIPTION OF THE DRAWINGS

FIG. 1 is an overview of the intelligent LED traffic signal module.

FIG. 2 is a block diagram of the intelligent LED traffic signal module.

### DETAILED DESCRIPTION OF THE INVENTION

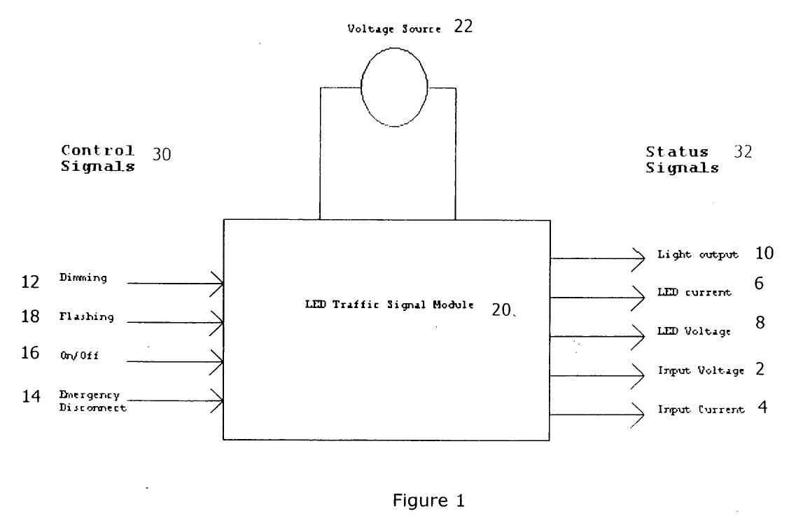

A general overview of the inventive LED traffic signal is shown in FIG. 1. The LED signal is connected to a non-switched voltage source 22. Voltage is permanently applied to the signal. Preferably, the signal can receive four control signals 30. Preferably, the control signals are on/off 16, dimming 12, flashing 18 and emergency disconnect 14. The ‘on’ control signal 16 turns the LED signal on, eliminating the need for a load switch. The ‘dimming’ control signal 12 dims the light output to pre-established level (used in conjunction with ‘on’ signal), eliminating the need for special dimming modules in the controller. The ‘flashing’ control signal 18 puts the signal in flashing mode, eliminating the need for controller flasher modules. The ‘emergency disconnect’ control signal 14 is used in case the LED signals does not respond to the off control signal 16. It results in a permanent open signal.

The intelligent LED module can provide feedback about the signal's status to the controller. Light output status 10 is given by a photocell mounted in the LED signal adjacent to the LEDs. This provides an indication if the signal is approaching a pre-defined end of life threshold due to normal LED light output degradation. The current 6 flowing through the LEDs as well as the LED array voltage 8 gives the electrical status of the LED array. These parameters are used in conjunction with the light output status 10 to validate that the power supply 24 is functioning normally. Input voltage 2 is an indication of normal supply voltage 22. Input current 4 is an indication that input signal current is normal. These two status signals are used to validate power supply status.

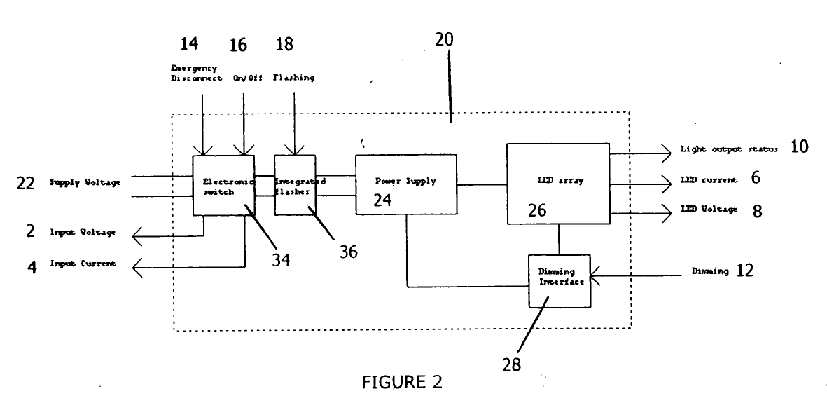

Referring to FIG. 2, a block diagram of the functions of the LED module is shown. The electronic switch 34 consists in an on/off switch controlled by the on/off command 16. The electronic switch 34 preferably is an opto triac switch. Other known switches may also be used. The emergency disconnect will blow an input fuse by shorting the supply line. This may be accomplished through a transistor or other device. Input and output voltage 2 are monitored. Input current 4 and output current 6 are sensed. The output voltage 8 is preferably monitored by a resistor divider. Other monitoring circuitry may be used. Preferably, the input current 4 is sensed by a resistor or current transformer.

The integrated flasher 36 comprises a timer circuit switching on and off the electronic switch at a pre-determined flashing rate. When the command signal disables it, this circuit is by-passed. When no flashing signal is received, the flasher is always on.

The dimming command 12 can be on/off, linear or pulse width modulation (PWM). The dimming interface 28 decodes the dimming command and scales down the power converter feedback loop accordingly.

The LED array 26 feeds back the following information: light output status 10; LED current status 6; and LED voltage 8. Preferably, the light output status 10 is provided by a photodiode. Alternative means of providing the light output status 10 may be used.

Preferably, the LED current status 6 is given by the voltage across a resistor in series with the LEDs. Preferably, the LED voltage status 8 is given by the voltage across the LEDs through a voltage divider.

1. An intelligent light emitting diode module for a traffic signal; comprising:
a voltage source, said voltage source continuously supplying a voltage to said traffic signal;
an electronic switch;
an integrated flasher;
at least one light element;
a power supply for powering the at least one light element;
a dimming interface for dimming the at least one light element;
a controller for generating an appropriate command signal based on one or more status signals,
said status signals comprise one or more of the following: light element current, light element voltage, light output, input current and input voltage and said appropriate command comprise one or more of the following: an on or off command, a dimming command, a flashing command, and an emergency disconnection signal;
a light sensor for detecting light output of the at least one light element;
a voltage detecting circuit for the light element voltage, and the output voltage or combinations thereof; and
a current monitoring circuit for measuring the light element current, the output current, or combinations thereof.

2. The module of claim 1 wherein the light sensor is a photocell mounted adjacent the at least one light element.

3. The module of claim 1 wherein the at least one light element is and LED array.

4. The module of claim 1 wherein the controller validates that the light array is functioning using the LED voltage, the LED current and the light output status.

5. The module of claim 1 wherein the controller validates the power supply status using the input current and the output current.

6. The module of claim 1 wherein the electronic switch is an on/off switch.

7. The module of claim 6 wherein the on/off switch is an opto-triac switch.

8. The module of claim 1 further comprising an emergency disconnect.

9. The module of claim 8 wherein the emergency disconnect is open to a circuit by blowing a fuse.

10. The module of claim 1 wherein the integrated flasher comprises a timer circuit.

11. The module of claim 10 wherein the timer circuit switches the electronic switch on and off at a predetermined flashing rate.

12. The module of claim 11 wherein the integrated flasher is enabled when the flashing command is generated by the controller.

13. The module of claim 11 wherein the timer circuit is bypassed when the flashing signal is not generated.

14. The module of claim 1 wherein the dimming interface decodes the dimming command and adjusts a power converter feedback loop in response to the dimming command.

15. The module of claim 14 wherein the dimming command is selected from the group consisting of on/off, linear and pulse width modulation.

16. An intelligent light emitting diode module for a traffic signal; comprising:
a voltage source, said voltage source continuously supplying a voltage to said traffic signal;
at least one LED array;
a power supply for powering the at least one LED array;
a controller for generating an appropriate command signal based on one or more status signals, said status signals comprise one or more of the following: light element current, light element voltage, light output, input current and input voltage and said appropriate command comprise one or more of the following: an on/off command, a dimming command, a flashing command, and an emergency disconnection signal;
an electronic switch turns the power supply on or off in response to the on/off command;
a light sensor for detecting light output of the at least one LED array;
a dimming interface for dimming the at least one LED array, said dimming interface capable of adjusting a power converter feedback loop in response to the dimming command;
an integrated flasher, said integrated flasher is enabled in response to the flashing command;
a voltage detecting circuit for the light element voltage, and the output voltage or combinations thereof; and
a current monitoring circuit for measuring the light element current, the output current, or combinations thereof.

17. The module of claim 16 wherein the controller is enabled to validate the power supply status and that the light array is functioning properly.

18. The module of claim 16 wherein the integrated flasher comprises a timer circuit, said timer circuit switches the electronic switch on and off at a predetermined flashing rate.

19. The module of claim 18 wherein the electronic switch is an opto-triac switch.

20. The module of claim 16 wherein the dimming interface decodes the dimming command and adjusts a power converter feed backloop in response to the dimming command.
